(19) United States
(12) Patent Application Publication
(10) Pub. No.: US 2015/0010028 A1
(43) Pub. Date: Jan. 8, 2015

(54) LASER DEVICE

(71) Applicants: INTER-UNIVERSITY RESEARCH INSTITUTE CORPORATION NATIONAL INSTITUTES OF NATURAL SCIENCES, Mitaka-shi, Tokyo (JP); OXIDE CORPORATION, Hokuto-shi, Yamanashi (JP)

(72) Inventors: Takunori Taira, Okazaki-shi (JP); Rakesh Bhandari, Okazaki-shi (JP); Yasunori Furukawa, Hokuto-shi (JP); Akio Miyamoto, Hokuto-shi (JP); Masayuki Habu, Hokuto-shi (JP); Tsuyoshi Tago, Hokuto-shi (JP)

(21) Appl. No.: 14/374,978

(22) PCT Filed: Sep. 19, 2012
(86) PCT No.: PCT/JP2012/005952

§ 371 Date: Jul. 28, 2014

(30) Foreign Application Priority Data
Jan. 27, 2012 (JP) 2012-015136

(51) Int. Cl. H01S 3/109; H01S 3/02

(52) U.S. Cl. CPC H01S 3/109; H01S 3/02
USPC 372/22

(57) ABSTRACT

Provided is an external resonance-type laser device with high wavelength conversion efficiency in which a nonlinear optical crystal is disposed outside of a resonator. The laser device includes a laser generation device configured to generate high-intensity laser light, a nonlinear optical crystal on which the high-intensity laser light generated by the laser generation device is incident and which is configured to generate a second harmonic wave light, and a different-element-fluxless-grown nonlinear optical crystal on which the second harmonic wave light generated by the nonlinear optical crystal is incident and which is configured to generate a fourth harmonic wave light. In the laser device, the different-element-fluxless-grown nonlinear optical crystal is not damaged even when high-intensity laser light of 100 MW/cm² or more is incident.

### TECHNICAL FIELD

The present invention relates to a laser device which converts a wavelength of laser light emitted from a laser oscillator, using a nonlinear optical crystal, and outputs the wavelength-converted laser light.

### BACKGROUND ART

Currently, a laser device has been developed in which harmonic waves are generated using, for example, nanosecond giant pulses due to a Q-switch type laser or ultra-short pulses from a mode-locked Ti: sapphire laser (for example, see Patent Document 1).

In addition, a laser device has also been reported in which a nonlinear optical crystal is inserted inside a resonator of a solid-state laser (for example, see Patent Document 2).

### CITATION LIST

### Patent Document

Patent Document 1: JP 2001-272704 A

Patent Document 2: JP 9-232664 A

### SUMMARY OF INVENTION

### Problem to be Solved by the Invention

Wavelength conversion efficiency η of a nonlinear optical crystal is expressed by the following equation.

η∝PL²d²

Here, “P” represents an intensity of incident light onto the nonlinear optical crystal, “L” represents a length of the nonlinear optical crystal, and “d” represents a nonlinear coefficient of the nonlinear optical crystal particularly using KDP (KH₂PO₄), BBO (β-BaB₂O₄), or LBO (LiB₃O₅).

Accordingly, in order to increase the efficiency η, it is necessary to enlarge the incident-light intensity P and the length L of the nonlinear optical crystal and use a crystal in which the nonlinear coefficient d is large.

In the existing Q-switch solid-state laser for giant pulses, since a pulse time width is generally on the order of nanoseconds in an oscillator single body, the intensity of light is enlarged by focusing Q-switched laser light using a lens and irradiating the nonlinear optical crystal with the focused light. Then, all of the length L cannot be used; only the length L near a portion on which the light is focused is used as an effective length, and thus the efficiency cannot be improved even when a large crystal is used.

In the mode-locked Ti: sapphire laser, since the pulse time width is on the order of femto seconds, fundamental wave light is generated with the high intensity so much when pulses of the same energy are provided. However, when the pulse time width is on the order of femtoseconds, a spectral bandwidth (Δλ) is widened from the relation of Fourier limit. Since the length L of the nonlinear optical crystal capable of performing phase matching with the fundamental wave light having the wide spectral bandwidth (Δλ) becomes shorter, the conversion efficiency cannot be improved.

Examples of a crystal growth method of the nonlinear optical crystal include a flux growth method and a fluxless growth method. Examples of the flux growth method include a different-element flux growth method in which a material having a composition different from a composition of a crystal to be grown is used as a flux and a self-flux growth method in which a material having the same composition as that of a crystal to be grown is used as a flux.

In contrast, the fluxless growth method is a growth method for growing a single crystal by controlling a pulling-up speed, a pulling-up orientation, or the like of the crystal without using a flux and is also called a melt growth method.

Previously, most of the nonlinear optical crystals were produced by the different-element flux growth method. For example, in the case of BBO (β-BaB₂O₄) single crystal, a method of precipitating β-phase single crystal by melting BaB₂O₄ in an oxide melt (different-element flux) having a composition different from BaB₂O₄ and then gradually cooling it, has been used. Examples of the flux include Na₂B₂O₄, Na₂O, NaF, NaCl, or the like.

In the nonlinear optical crystal produced by the different-element flux growth method, since flux components are mixed as impurities, the crystalline quality is low, and since the impurities become a scatterer or the cause of absorption occurrence, wavelength conversion efficiency tends to be reduced in general. In addition, due to the impurities, new levels are generated and thus two-photon absorption easily occurs. Therefore, in many cases, a problem may occur in the case of increasing the incident-light intensity P in order to improve the wavelength conversion efficiency.

In an internal resonance-type laser device in which the nonlinear optical crystal is inserted inside the resonator of the solid-state laser, when an angle of the nonlinear optical crystal is adjusted for the phase matching, there are fears that a Q-value of the resonator is reduced and thus oscillation becomes unstable.

The present invention has been made in view of the above problems and an object thereof is to provide an external resonance-type laser device with high wavelength conversion efficiency in which the nonlinear optical crystal is disposed outside the resonator.

### Means for Solved the Problem

In order to solve the problem, the laser device of the present invention is characterized by including a laser generation means configured to generate high-intensity laser light, a nonlinear optical crystal on which the high-intensity laser light generated by the laser generation means is incident and which is configured to generate a second harmonic wave light, and a different-element-fluxless-grown nonlinear optical crystal on which the second harmonic wave light generated by the nonlinear optical crystal is incident and which is configured to generate a fourth harmonic wave light. In the laser device, the different-element-fluxless-grown nonlinear optical crystal is not damaged even when high-intensity laser light of 100 MW/cm² or more is incident.

When the pulse energy is the same, the laser intensity increases as the pulse time width is shorter, but if the pulse time width is on the order of femtoseconds as in the mode-locked laser, the spectral bandwidth (Δλ) of the laser light is wide. Since the length L of the nonlinear optical crystal capable of performing the phase matching with the laser light having the wide spectral bandwidth (Δλ) becomes shorter, the conversion efficiency cannot be improved.

The laser light having the pulse time width of picoseconds to nanoseconds is easily generated from a passive Q-switched microchip laser. In the laser light of picoseconds to nanoseconds, since the spectral bandwidth (Δλ) is narrow and the phase matching can be performed even when the length L of the nonlinear optical crystal becomes longer, the wavelength conversion efficiency can be improved.

In addition, according to the recent technique of Taira et al, energy of millijoules or more is expected even in a configuration of the microchip laser, the laser light is obtained with high intensity (100 MW/cm² or more), and thus the light is not required to be collectively irradiated on the nonlinear optical crystal and the length L of the nonlinear optical crystal can be made longer.

Further, since the nonlinear optical crystal is the different-element-fluxless-grown nonlinear optical crystal, an optical damage due to two-photon absorption is suppressed and thus it is possible to improve the wavelength conversion efficiency.

Further, since the high-intensity laser light generated from the laser generation means is converted into the second harmonic wave light using the nonlinear optical crystal and then is converted into the fourth harmonic wave light using the different-element-fluxless-grown nonlinear optical crystal, it is possible to effectively generate ultraviolet laser light.

In addition, the pulse time width may be 10 ps to 5 ns.

When the pulse time width by the microchip laser of millijoules or more according to the recent technique of Taira et al. is 5 ns or less, the intensity of the laser light is high and the light is not need to be focused by the lens in order to increase the incident-light intensity. When the light is focused by the lens, only the vicinity of the portion on which the light is focused corresponds to the length of the nonlinear optical crystal, and thus the conversion efficiency cannot be improved. When the pulse time width is 10 ps or more, the spectral bandwidth also becomes sufficiently narrow, and the phase matching can be easily performed even when the crystal length is made longer.

In addition, the different-element-fluxless-grown nonlinear optical crystal may be a melt (fluxless)-grown nonlinear optical crystal or a self-flux-grown nonlinear optical crystal.

The optical damage due to two-photon absorption can be further suppressed, and the wavelength conversion efficiency can be further improved.

In addition, the melt (fluxless)-grown nonlinear optical crystal may be a melt (fluxless)-grown β-BaB₂O₄ (beta-barium borate).

The optical damage due to two-photon absorption can be further suppressed, and the wavelength conversion efficiency can be further improved.

### Effects of the Invention

In the high-intensity giant pulse laser light having the pulse time width of picoseconds to nanoseconds, since the spectral bandwidth (Δλ) is narrow and the phase matching can be performed even when the length L of the nonlinear optical crystal becomes longer, the wavelength conversion efficiency can be improved. In addition, since the laser light is obtained with the high intensity, the light is not required to be collectively irradiated on the nonlinear optical crystal and the length L of the nonlinear optical crystal can be made longer.

Since the nonlinear optical crystal is the different-element-fluxless-grown nonlinear optical crystal, the optical damage due to two-photon absorption can be suppressed, and the wavelength conversion efficiency can be improved.

### BRIEF DESCRIPTION OF THE DRAWINGS

FIG. 1 is a schematic configuration diagram of a laser device according to a first embodiment of the present invention.

FIG. 2 is a schematic configuration diagram a laser device according to a second embodiment of the present invention.

FIG. 3 is a schematic configuration diagram of a laser device according to Example 1.

FIG. 4 is a graph illustrating a relation between conversion efficiency and incident-light intensity of a fourth harmonic wave.

### DESCRIPTION OF EMBODIMENTS

### First Embodiment

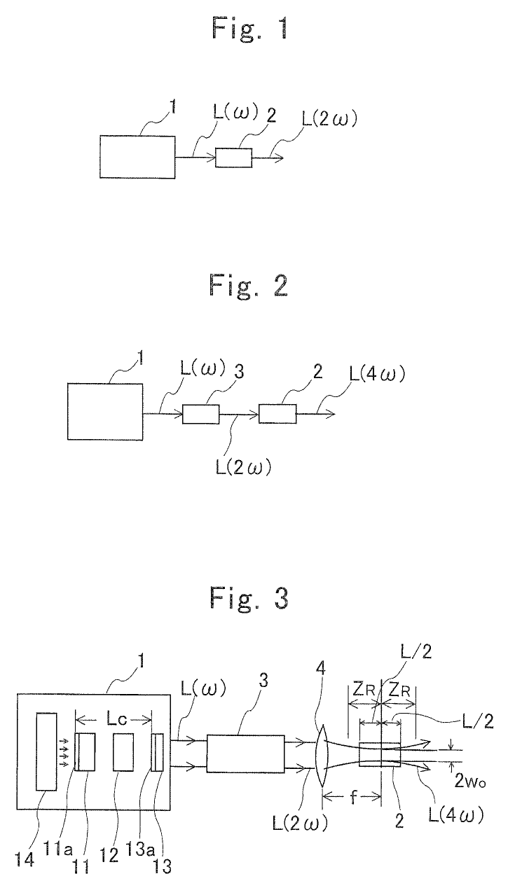

As illustrated in FIG. 1, a laser device according to the present embodiment includes a laser generation means 1 that generates high-intensity laser light L(ω) having a pulse time width of picoseconds to nanoseconds and a different-element-fluxless-grown nonlinear optical crystal 2 on which the high-intensity laser light L(ω) is incident and which is configured to generate second harmonic wave light L(2ω). Here, “ω” indicates an angular frequency, and when a wavelength represents and a velocity of light represents “c”, the condition of ω=2πc/λ is satisfied. Accordingly, when the wavelength of L(ω) is λ, the wavelength of L(2ω) is λ/2.

As the laser generation means 1, peak power may be sub-megawatt or more with the pulse time width of picoseconds to nanoseconds. A Q-switched bulk YAG laser or a Q-switched bulk ruby laser may be also used as the laser generation means, but in the Q-switched bulk laser, the pulse time width is difficult to make picoseconds to nanoseconds.

In contrast, since a Q-switched microchip laser has a short cavity length and can easily generate the laser light of which the pulse time width is picoseconds to nanoseconds, it is preferably used as the laser generation means.

As the different-element-fluxless-grown nonlinear optical crystal 2, for example, a self-flux-grown LBO (LiB₃O₅), a self-flux-grown KTP (KTiOPO₄), a self-flux-grown YAB (YAl₃(BO₃)₄), a self-flux-grown KN(KNbO₃), a self-flux-grown Mg-doped LN (Mg-doped LiNbO₃), and a self-flux-grown Mg-doped LT (Mg-doped LiTaO₃) or a melt (fluxless)-grown BBO (β-BaB₂O₄), a melt (fluxless)-grown CLBO (CsLiB₆O₁₀), a melt (fluxless)-grown CBO (CsB₃O₅), a melt (fluxless)-grown YCOB (YCa₄O(BO₃)₃), a melt (fluxless)-grown Mg-doped LN (Mg-doped LiNbO₃), a melt (fluxless)-grown Mg-doped LT (Mg-doped LiTaO₃), and a melt (fluxless)-grown LBGO (LaBGeO₅) can be used. These crystals may be used in the form of performing phase matching using a birefrigence in a state of perfect single crystal or may be used in the form of performing the phase matching in a pseudo manner by periodically inverting a crystal structure.

Since the laser device according to the present embodiment includes the different-element-fluxless-grown nonlinear optical crystal 2, it is possible to convert the laser light L(ω) emitted from the laser generation means 1 into the second harmonic wave light L(2ω) with high efficiency.

(Second Embodiment) As illustrated in FIG. 2, a laser device according to the present embodiment differs from the laser device according to the first embodiment in that a nonlinear optical crystal 3 is provided between the laser generation means 1 and the different-element-fluxless-grown nonlinear optical crystal 2 of the laser device according to the first embodiment.

As the nonlinear optical crystal 3, either of a different-element-fluxless-grown nonlinear optical crystal or a different-element-flux-grown nonlinear optical crystal may be used, but the different-element-fluxless-grown nonlinear optical crystal is preferred.

Since ultraviolet or extreme ultraviolet laser light has high photon energy, it is expected to be applicable to various applications, but lasers other than an excimer laser or the like are difficult to cause a direct laser oscillation.

Since the laser device according to the present embodiment converts the laser light L(ω) emitted from the laser generation means 1 into the second harmonic wave light L(2ω) using the nonlinear optical crystal 3 and converts the second harmonic wave light into fourth harmonic wave light L(4ω) using the different-element-fluxless-grown nonlinear optical crystal 2, it is possible to efficiently generate extremely-short ultraviolet laser light.

Since the laser oscillation is easily caused when the photon energy is low (a wavelength is long), high-intensity laser light is concentrated in a near infrared region (having a wavelength of around 1000 nm). When the wavelength (λ) of L(ω) is 1064 nm, the wavelength of L(4ω) corresponds to the wavelength of extreme ultraviolet light of 266 nm (=λ/4). Accordingly, the laser device according to the present embodiment can efficiently generate the extreme ultraviolet laser light.

### EXAMPLE

A laser device according to Example is configured to put a lens 4 behind the nonlinear optical crystal 3 of the laser device according to the second embodiment, so that the second harmonic wave light L(2ω) subjected to the wavelength conversion using the nonlinear optical crystal 3 is softly focused on the different-element-fluxless-grown nonlinear optical crystal 2.

The laser generation means 1 is a passive Q-switched microchip laser, reference numeral 11 indicates a 1.1 at.% [111]-cut Nd: YAG crystal with a size of Φ5×4 mm (Scientific Materials Corp.). Reference numeral 11a indicates a film having high reflectance to light of 1064 nm and having high transmittance to light of 808 nm. Reference numeral 12 indicates a [100]-cut Cr⁴⁺: YAG crystal with initial transmittance of 30% and a size of Φ5×4 mm (Scientific Materials Corp.). Reference numeral 13 indicates an output coupler, and reference numeral 13a indicates a film having transmittance of 50% to the light of 1064 nm. Reference numeral 14 indicates an excitation semiconductor laser which generates 120-W laser light with a wavelength of 808 nm and a repetition frequency of 100 Hz. A cavity length Lc is 11 mm.

The laser generation means 1 could generate the laser light L(ω) having a wavelength of 1064 nm, a pulse time width of 365 ps, pulse energy of 3 mJ, peak power of 8.2 MW, a repetition frequency of 100 Hz, a beam diameter of 1 mm, and M²=3.5.

As a result of using the different-element-flux-grown LBO (LiB₃O₅) of 3×3×10 mm in the nonlinear optical crystal 3, when the laser light L(ω) has a wavelength of 1064 nm and peak power of 7.4 MW, the second harmonic wave light L(2ω) having a wavelength of 532 nm and peak power of 6.3 MW was obtained. Therefore, the wavelength conversion efficiency of the nonlinear optical crystal 3 is 85%.

A melt (fluxless)-grown BBO (β-BaB₂O₄) of 3×3×6 mm was used in the different-element-fluxless-grown nonlinear optical crystal 2, and an intermediate point of the length L of 6 mm was conformed with a focal point of a convex lens 4 having a focal distance “f” of 100 mm. When a light-collected spot diameter is 2w₀ (=0.82 mm) at the focal point, a distance Z_{R} (=13.7 mm) from the focal point is called a Rayleign range to be 2√2w₀ which is twice of a square root of 2w₀ across the focal point, and 2Z_{R} (=27.4 mm) is called a confocal length. The conversion efficiency at the focal position may be improved by reducing the light-collected spot diameter with a lens having a short focal length and increasing the intensity (=power/area of light-focused spot) of the incident laser light at such a position, but if the light is focused by the lens having the short focal length, the spot diameter sharply increase (incident-light intensity decrease) in the case of slightly deviating from the focal point and the conversion efficiency is reduced at a position deviating from the focal point. In addition, since the incident-light intensity is also high at the focal position, the conversion efficiency is reduced by a combination of two-photon absorption and pump consumption. Therefore, in the present Example, as described above, a lens having a long focal length was used as the lens 4, the confocal length 2Z_{R} was set to be longer than the length L of the different-element-fluxless-grown nonlinear optical crystal 2, and the spot diameter at both ends of the different-element-fluxless-grown nonlinear optical crystal 2 was set to be less than 2√2w₀. Such a light-collection and irradiation is referred to as a soft focus.

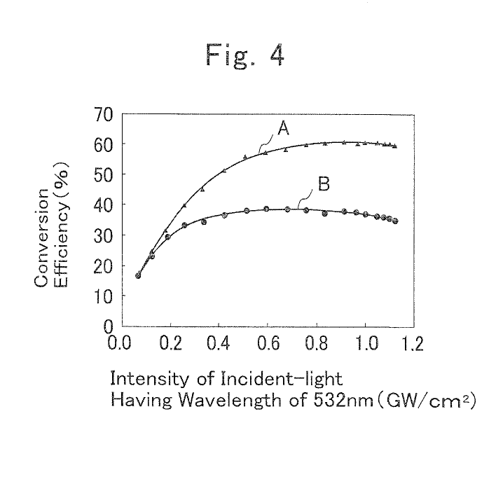

FIG. 4 illustrates a relation between conversion efficiency and incident-light intensity of the fourth harmonic wave light L(4ω) when the second harmonic wave light L(2ω) having a wavelength of 532 nm is collectively irradiated on the melt (fluxless)-grown BBO (β-BaB₂O₄) 2 using the lens 4.

In the case of the present Example, from a curve “A” in FIG. 4, it can be seen that the saturation of the conversion efficiency occurs from 0.6 GW/cm² and the conversion efficiency reaches about 60%.

### Comparative Example

Comparative Example is the same as Example except that the melt (fluxless)-grown BBO (β-BaB₂O₄) 2 is changed into a different-element-flux-grown BBO (β-BaB₂O₄) in the laser device of Example.

FIG. 4 illustrates a relation between conversion efficiency and incident-light intensity of the fourth harmonic wave light L(4ω) when the second harmonic wave light L(2ω) having a wavelength of 532 nm is collectively irradiated on the different-element-flux-grown BBO (β-BaB₂O₄) 2 using the lens 4.

In the case of the present Comparative Example, from a curve “B” in FIG. 4, it can be seen that the saturation of the conversion efficiency occurs from 0.3 GW/cm² and the conversion efficiency reaches about 35%.

In the case of the different-element-flux-grown BBO (β-BaB₂O₄), it is considered that the saturation of the conversion efficiency occurs in the low intensity of 0.3 GW/cm² due to two-photon absorption.

### REFERENCE SIGNS LIST

1 laser generation means
2 different-element-fluxless-grown nonlinear optical crystal
3 nonlinear optical crystal

1. A laser device comprising:
a laser generation means configured to generate high-intensity laser light;
a nonlinear optical crystal on which the high-intensity laser light generated by the laser generation means is incident and which is configured to generate a second harmonic wave light;
a lens configured to focus the second harmonic wave light generated by the nonlinear optical crystal; and
a different-element-fluxless-grown nonlinear optical crystal that has a length L and is disposed such that an intermediate portion thereof is positioned at a focal point of the lens,
wherein a confocal length of the lens is longer than the length L, and the different-element-fluxless-grown nonlinear optical crystal is not damaged even when high-intensity laser light of 100 MW/cm² or more is incident.

2. The laser device according to claim 1, wherein the high-intensity laser light has a pulse time width from 10 ps to 5 ns.

3. The laser device according to claim 1, wherein the different-element-fluxless-grown nonlinear optical crystal is a melt (fluxless)-grown nonlinear optical crystal or a self-flux-grown nonlinear optical crystal.

4. The laser device according to claim 3, wherein the melt (fluxless)-grown nonlinear optical crystal is a melt (fluxless)-grown β-BaB₂O₄ (beta-barium borate).
